(19) United States
(12) Patent Application Publication
(10) Pub. No.: US 2024/0278518 A1
(43) Pub. Date: Aug. 22, 2024

(54) STRUCTURE AND PROCEDURE FOR MAKING A SHOE WITH KNITTED UPPER

(71) Applicant: TRERE' INNOVATION S.r.l., Asola (Mantova) (IT)

(72) Inventor: Marco REDINI, Asola (IT)

(21) Appl. No.: 18/566,836

(22) PCT Filed: Jun. 9, 2022
(86) PCT No.: PCT/IT2022/000027

§ 371 Date: Dec. 4, 2023

(30) Foreign Application Priority Data
Jun. 9, 2021 (IT) 102021000015113

(51) Int. Cl. B29D 35/04; A43B 1/04; A43B 9/18; A43B 23/02; A43B 23/17; B29D 35/00

(52) U.S. Cl. CPC B29D 35/04; A43B 1/04; A43B 9/18; A43B 23/0235; A43B 23/17; B29D 35/0009

(57) ABSTRACT

A procedure for making a shoe with a knitted upper, including a series of steps in which—during an upper shaping step—once the internal stocking has been placed on the shoe tree, a membrane element (3) is placed in position, which covers the portion corresponding to the sole of the shoe tree and a lateral portion. The membrane element is a single-body element formed of a polymer membrane that has adhesive material on both sides thereof and features a series of suitable shaped and positioned perforations (30). The membrane element is designed to create a support structure for the two stockings so that the shoe obtained has and maintains a structured shape. Once the upper is complete, a sole is constructed by injection moulding in order to create a shoe that is a single, homogeneous, compact, and structured body.

### TECHNICAL FIELD

The present invention relates to a structure and procedure for making a shoe with a knitted upper which is particularly designed to offer greater protection for the foot and optimal flexibility during use.

### BACKGROUND ART

As is known, footwear is a clothing accessory whose task is to protect feet and is essentially made up of a sole, which is the lower part which comes into contact with the ground, and an upper, which is the upper part and generally consists of several parts to cover the foot and hold the sole in position. In particular, the upper may have different ornaments, colours, and shapes and is joined to the sole by means of seams or gluing. Furthermore, in footwear there is often an insole, which is the internal part—between the sole and the upper—on top of which the foot rests.

In fact, shoes are objects that have always been used to protect feet when the user is walking, running, etc., to prevent impacts injuring or causing fatigue in the bone and/or muscular structure of the foot.

At present, there are many types of shoes on the market and a major part thereof consists of sports shoes/casual shoes, which represent a large share of the market.

Nowadays, for leisure and other purposes, many people wear shoes with a knitted upper because such uppers offer comfort due to the softness thereof, as well as the breathability and lightness thereof.

This type of shoe has been on the market for a few years and the earliest kind were football boots made with a knitted upper that was covered with a thin layer of leather to protect the knitting. This shoe, which offers optimal comfort, has encountered problems arising from the
delicacy of the upper, the wearability thereof, and the poor protection offered to areas of the foot subject to impacts and blows, as well as the limited breathability thereof, and the fact that the structure of the upper is likely to lose shape with use. In fact, the thickness of the constituent fabric is constant, but the different parts of the foot require the fabric to have different levels of grip, resistance, and consistency.

Subsequently, the knitted upper was made by constructing a “stocking” using inlay machines or circular machines in which the stocking is composed of the structure of two stockings that are joined at the toe by adding heat-setting yarns to the processing. Once the processing is complete, one stocking is rolled down onto the other and undergoes a hardening and stabilisation process involving time spent in a kiln and high-temperature steam.

Another type involves the addition of a third stocking made entirely of a heat-setting material which is subsequently inserted between the other two.

Also in this case, the structure obtained undergoes a hardening and stabilisation process involving time spent in a kiln and high-temperature steam.

The shoes described above have posed critical issues due to the limited elasticity and breathability attributable to the presence of heat-setting yarns throughout the knitted fabric which, among other things, make the shoe rigid and inflexible.

Furthermore and not finally, the upper is assembled with the sole by gluing—which leads to further problems consisting of rigidity, limited grip between the components upon movement, and the presence of glue infiltrations in the knitted fabric, which are uncomfortable and hard upon contact with the skin of the foot—or by sewing, but also in this case problems have been encountered linked to the wear caused by the yarn rubbing against the knitted fabric of the upper, in addition to other problems arising from the moulding of the sole.

More specifically, the applicant is aware of patent application US 2017/0181501, which describes a shoe made with the techniques described above wherein the upper is composed of
two stockings, one rolled down on top of the other, and with an insole interposed therebetween to improve comfort for the foot, in the part touching the sole, and to provide a structure which features a surface which can be joined to the sole. Furthermore, other functional elements called ‘envelopes’ are interposed between the two stockings to improve certain functions and create sectors designed to protect the foot. In particular, the construction of the upper envisages the presence of a structure that serves to accommodate the laces for fastening the shoe onto which the stockings are then fitted.

In particular, the aforesaid patent application describes how the upper and the sole are mutually assembled by means of gluing or sewing techniques.

This shoe also experiences the problems described above, namely poor overall flexibility of the shoe and lack of protection in the required areas, in addition to the wear of the upper when sewn.

A further problem encountered arises from the tendency of the upper to collapse since it is not suitably stabilised dimensionally, which means the upper tends to cave in, losing its shape over time.

In order to solve the problems described above, the Applicant has devised a knitted shoe structure and a procedure for making it as described in patent application PCT/IT2021/000001.

The procedure described in the aforesaid patent application for the production of a shoe with a knitted upper comprises a first step consisting of the knitting/construction of an upper comprised of a double stocking, followed by a second upper shaping step in which the two stockings have the appearance of a sort of “tube” which is sealed at one part (the toe), while the other end of the tube remains open, and the internal stocking is placed on a special shoe tree and the external stocking is rolled down over the internal stocking to form a double layer.

This is followed by a steaming step, in which the upper on the shoe tree is subjected to a jet of steam that dampens and softens a heat-setting polymer yarn present in the knitting, followed by a drying step, in which the upper is placed in a high temperature kiln to remove the moisture remaining from the previous step and bring the upper back to the desired dimensions by bringing the heat-setting polymer yarn to melting temperature. The procedure then involves a stopping step, in which the upper on the shoe tree yields heat to the environment, thereby lowering the temperature thereof, followed by a stabilisation step, in which the upper on the shoe tree moves through a very low temperature refrigerator which stabilises the heat-setting polymer yarn to fix the upper dimensionally, continuing with a step consisting of removing the upper from the shoe tree when the upper is at room temperature. In particular, the procedure envisages that during the step in which the upper is put on the shoe tree, an in sole is also placed in position, the said in sole having a plantar structure covering the entire surface area of the shoe tree and featuring a series of suitably shaped and positioned slots.

Once removed from the shoe tree, the upper is ready for the construction of a sole in which the steps consisting of fitting the upper onto a special shoe tree on a mould, positioning the shoe tree with the upper placed thereon, and then sealing it between two moulding rings envisaged for a polyurethane injection step, in which the moulding rings for the sole close so as to partially incorporate the upper and hence form a cavity which is isolated from the outside and is suitable for the injection of polyurethane in order to fill the mould and thus make the sole.

During the injection step, the presence of the plantar structure limits the flow of polyurethane towards the inner part of the upper, allowing only predetermined quantities of polyurethane to flow through the slots and therefore create joint points between the sole and the upper and with the internal stocking, without interfering with and without altering either functional or aesthetic characteristics. At the end of the injection step, the moulding rings are opened and
the shoe is removed from the mould, which is now complete (upper+sole), the shoe is removed from the shoe tree and a shoe is obtained which is a single, homogeneous, and compact body.

With the procedure just described and the shoe obtained, many aspects have been improved and various problems encountered with the shoes previously in use have been overcome, but some limitations have arisen which are attributable to the fact that the presence of the plantar structure removed elasticity, thereby making the shoe more rigid.

Furthermore, the shoe has shown reduced flexibility of the sole which, over time, has limited practicality of use thereof and comfort for the foot.

A further drawback encountered in the Applicant's shoe is due to the fact that the toe has proved to be rather delicate in terms of both allowing dampness to enter and offering limited protection for the toes from impacts and blows.

A need has emerged in the market for a shoe that has an extremely flexible sole, thus allowing very free movement, and is lightweight and very practical.

### DISCLOSURE OF INVENTION

The object of the present invention is essentially to solve the problems of the prior art by overcoming the difficulties described above through a structure and procedure for making a shoe with a knitted upper which allows the construction of a shoe with a knitted upper which is particularly flexible and better protects the most exposed and delicate parts of the foot, while also being lightweight and very flexible.

A second object of the present invention is to provide a structure and procedure for making a shoe with a knitted upper that has differentiated structures so as to offer good elasticity and flexibility, with an upper featuring optimal structuring of the areas that contain the foot which are elasticised, rigid, breathable, and structured for containment.

Another object of the present invention is to provide a structure and procedure for making a shoe with a knitted upper which has good dimensional stability, maintaining the same shape over time with considerable elasticity.

Another object of the present invention is to provide a structure and procedure for making a shoe with a knitted upper which adapts perfectly to the morphology of the foot, featuring differentiated functions and behaviour to meet all the usage needs and which swaddles and holds the user's foot, with optimal breathability, but at the same time offers protection against external water and dampness, decidedly light weight, and considerable comfort when worn, as well as significant flexibility and lightness during use thereof.

A further object of the present invention is to provide a structure and procedure for making a shoe with a knitted upper that has a faster construction sequence without the interposition of a plantar structure between the stocking and the sole.

A further not final object of the present invention is to provide a structure and procedure for making a shoe with a knitted upper that is simple to manufacture and works well.

These aims and others besides, which will become clearer over the course of the present description, are essentially achieved by means of a structure and procedure for making a shoe with a knitted upper according to the claims that follow.

### BRIEF DESCRIPTION OF DRAWINGS

Further characteristics and advantages will emerge from the detailed description of a structure and procedure for making a shoe with a knitted upper according to the present invention including references to the accompanying drawings, provided merely as non-limiting examples, in which:

FIG. 1 is a schematic side view of a shoe obtained with the procedure according to the present invention;

FIG. 2 is a schematic, partially sectioned side view of the shoe in FIG. 1 showing construction details;

FIG. 3 is a schematic, exploded view of the components of the shoe obtained with the procedure in question;

FIG. 4 is a schematic, perspective top-down view of a component of the shoe in FIG. 1;

FIG. 5 is a schematic, perspective bottom-up view of the component in FIG. 4;

FIG. 6 is a schematic, perspective side view of the component in FIG. 4;

FIG. 7 shows the component in FIG. 4 while being processed.

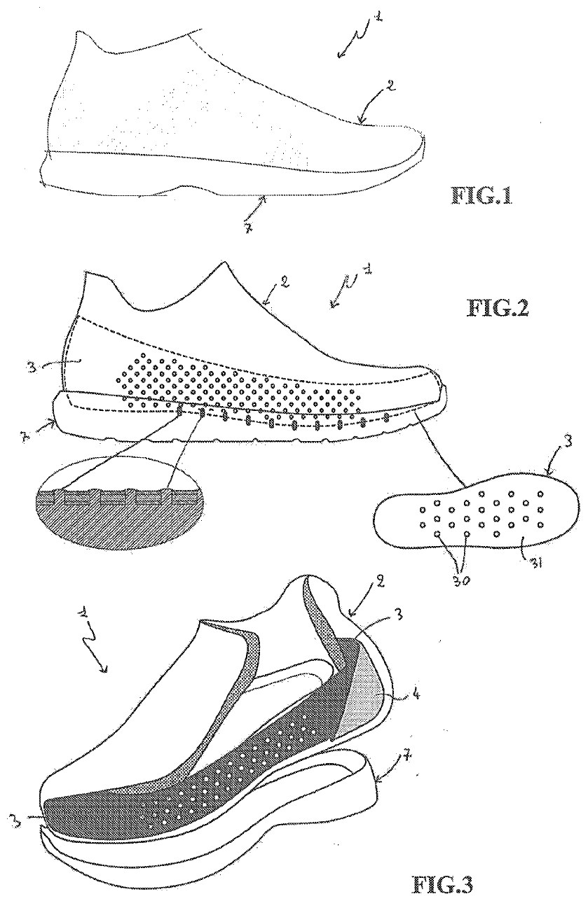

With reference to the aforesaid figures, and in particular to FIG. 1, a shoe with an upper and sole obtained according to the present invention is denoted 1.

### BEST MODE FOR CARRYING OUT THE INVENTION

As mentioned earlier, the procedure for making a shoe with a knitted upper involves a sequence of steps, some of which are already used to make shoes currently available on the market.

A first step involves the knitting/construction of an upper 2, which is made by constructing a double stocking starting from the toe, which is scaled directly by the machine, then continuing with the foot portion through to the heel, and ending with an edge, followed by a sequence of parts located opposite those made earlier, i.e. the second edge, heel, foot portion and ending with a second toe which, however, is not sealed.

The two stockings are assembled to make the upper in the form of a double layer, rather like a double skin, where one stocking constitutes the outside of the upper and is made using natural, synthetic, and/or mixed yarns while the other stocking constitutes the inside of the upper and is mainly constituted of yarns of another kind—which are preferably natural, such as wool, for example—to provide other features such as: breathability, comfort, thermal insulation, etc.). In addition to the yarns just mentioned, an additional thermoplastic polymer
yarn is added to the knitting throughout the construction of the upper and is added to both stockings in well-defined areas with different densities so as to provide diversified elasticity, reinforcement, and breathability properties. In more detail, the thermoplastic polymer yarn is used in a higher percentage in the external stocking, which lends the structure of the upper greater durability and resistance.

In addition, the said polymer yarn used in the processing acts as a binder between the two stockings so that when they are joined together, they form the upper as if it were a single piece.

The second step is for shaping the upper. In this step, the two stockings constructed earlier have the appearance of a ‘tube’ which is sealed at one part (the toe sealed during processing), while the other end of the tube remains open. In this step, the internal stocking is placed on a special shoe tree and the external stocking is rolled down over the previous stocking to form the double-layered upper.

Once the internal stocking has been placed on the shoe tree, a membrane element 3 is placed in position, which covers the portion corresponding to the sole of the shoe tree and a lateral portion, as shown in FIG. 6.

Once the membrane element has been positioned, the second stocking with open ends is then pulled over the first to completely cover the shoe tree.

In the present embodiment, the membrane element 3 is a single-body element, consisting of a polymer membrane with a thickness ranging from a minimum of 0.5 mm to a maximum of 1.5 mm, depending on the level of performance desired from the shoe.

As the membrane thickness increases, the upper (and consequently the shoe) obtains differentiated elasticity.

In fact, increasing the thickness of the membrane element increases the shoe's insulation capacity, thereby maintaining the internal temperature and ensuring good foot comfort.

Another function of the membrane is to create a support structure for the two stockings which, as they are knitted, would not be able to support themselves. In this way, the shoe obtained has and maintains a structured shape.

In addition to the above, the membrane is constituted of a closed cell polymer that offers good protection of both the knitted part and the user's foot. Furthermore, it is a heat-sealing double-sided adhesive membrane, i.e. the said membrane is equipped with a film of adhesive material on both sides thereof, whose function will be described later.

According to the present embodiment, the said membrane element 3 is composed of a first portion 31 which corresponds to the conformation of the sole, of a second portion 32—which creates a side edge that runs from the heel, up the instep, to the toe and ends at the beginning of the outer forefoot—and a third portion 33, which starts at the heel and meets the second portion at the outer forefoot.

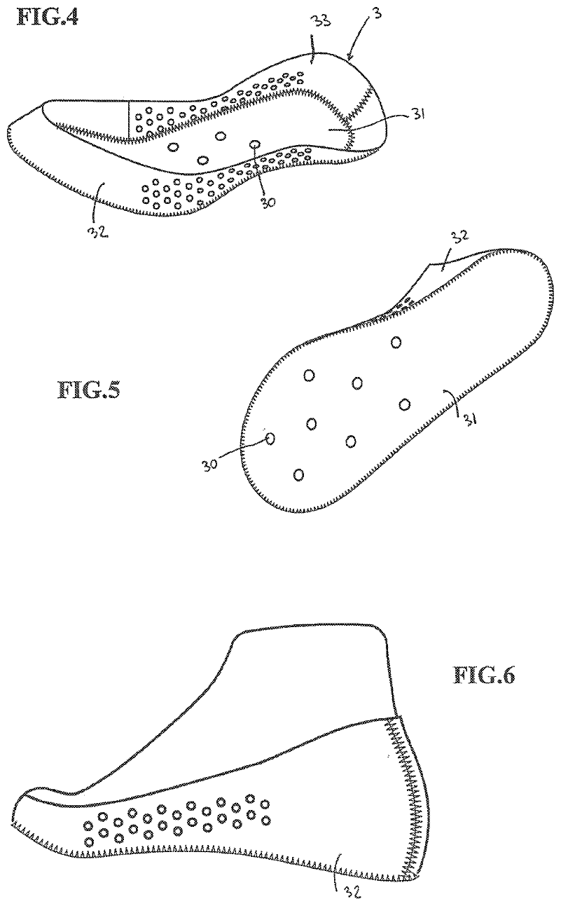

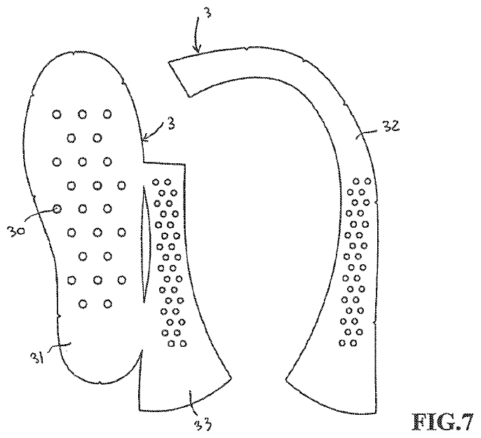

In more detail, the three portions are obtained from a single piece of a membrane shect, from which they are cut out by die-cutting. Once the shape has been cut out, the second portion is joined by sewing along the perimeter edge of the first portion (for the section that includes the heel, the instep, and the toe, up to the outer side at the outer forefoot), while the third portion is joined to the first portion, also along the peripheral edge of the first portion not affected by the second portion (in the portion that goes from the outer forefoot to the heel). Furthermore, the second portion is joined to the third vertically at the heel and the external forefoot, as shown in FIG. 4.

In addition to the above, the first portion has a series of perforations 30, which are positioned so as to create adhesion points between the sole and the upper when the polyurethane is injected into the mould to create the sole.

In more detail, the shape of the membrane element 3 prevents the polyurethane injected for the sole from flowing towards the internal stocking, allowing only predetermined amounts of polyurethane to flow through, and only through the perforations 30. The amount of material
that flows through the perforations allows the creation of joint points between the sole and the upper and, in particular, with the internal stocking.

In fact, the single-body membrane element acts as a shield against the polyurethane injected for the sole, which therefore stops the said polyurethane “polluting” the upper on the inside.

In addition to the above and as shown in FIG. 6, the second and third portions of the single-body membrane element have a vertical height which varies from area to area along the entire perimeter of the foot depending on the desired structural performance, thereby creating a protective edge which, depending on the position, allows the toe to be protected against blows and the possible entry of water or dampness in the event of rain or water on the ground, also protecting the internal side part against the entry of water or dampness and providing a support and holding structure for the plantar arch area, while the external side part provides protection against blows and the possible entry of water or dampness. The edge also offers dimensional stability that ensures the shape of the upper is maintained over time and during use. Finally, in the heel area, the edge that is created is higher, so as to lend the said area greater stability, as well as lending the upper greater wear resistance.

In accordance with the present invention, the second and third portions have perforations to lend the shoe different degrees of breathability, as shown in FIG. 4.

Furthermore, the shape of the element 3 means reinforcement structures and/or collars are not needed (unlike until now), except in the heel, as shown in FIG. 2.

According to the present invention, the interposition of the single-body membrane element offers an improvement on the plantar structure previously used by the Applicant. Furthermore, an improvement in the production procedure has been noted in terms of speed, which has been reduced from 60 seconds to 40 seconds for the upper stabilisation step.

In particular, an improvement and an increase in the lightness of the shoe overall has also been found, and likewise in the flexibility of the sole, offering characteristics that reduce the foot fatigue caused by wearing the shoe for several hours, in addition to the fact that the
anterior musculature of the leg used to lift the toe makes less effort and therefore the possibility of tendinosis or tendinitis caused by prolonged use is reduced.

The improved flexibility of the shoe and sole ensures the muscle force produced by the rear leg muscles is fully discharge to the ground, which results in better performance and less muscle fatigue for the entire lower limb over time.

In addition to the above, the improved flexibility promotes more efficient and harmonious work between the anterior and posterior musculature of the leg, which therefore manages to work in sequence in an optimal, energy-saving way for the user.

In accordance with the present invention, it has been found that the element 3, with its structure and conformation, can also be used with soles that are moulded and then glued to the upper.

Returning to the procedure for making the shoe, and as mentioned earlier, the external stocking is then pulled and repositioned so that the upper is closed and adapts perfectly to the shoe tree, and then the open edge is brought to the lower portion, at the toe joint.

The following two steps are of a known type, in the first of which the upper is subjected to a jet of steam which dampens and softens the thermoplastic polymer yarn. This step ensures the upper adheres better to the shoe tree and prepares it for the next step, in which the said upper transits through a high-temperature kiln so as to dry out any dampness remaining from the previous step and to make the upper return to the desired dimensions by bringing the thermoplastic polymer yarn to melting temperature.

In more detail, when the upper transits through the kiln, the adhesive material present on the surfaces of the membrane element heats up, activates, softens, and starts to melt and therefore flow between the stitches of the internal and external stockings, creating a bridge to form cohesion between the two layers of knitting and giving rise to a single structure.

In fact, the said membrane element, adhering to the two layers of knitting (i.e. to the two stockings), lends support to the knitting and therefore structure to the shoe. In this way,
additional structural elements are no longer required, unlike in many shoes currently available on the market, which—however—become uncomfortable over time and with use because they are more rigid than knitted elements, and become a sort of foreign body.

In this case, the resulting upper structure is a single body, which is nevertheless soft because the membrane is elastic and contains air within its closed cell structure.

There now follows a step referred to as a ‘parking’ step, which is a transition between the previous step and the following one, in which the upper on the shoe tree comes out of the kiln and moves along a roller conveyor, dissipating heat into the surrounding air in order to cool, before moving on to the next step, i.e. the stabilisation step, in which the temperature is lowered still further.

In more detail, the parking step is a transition step whose purpose is to prevent there being too great a difference in the temperature between the time spent in the kiln and the stabilisation step that follows.

In the stabilisation step, the upper on the shoe tree transits through a very low-temperature refrigerator that stabilises the thermoplastic polymer yarn and the upper is fixed dimensionally in this step. In this step, the adhesive material of the membrane softened earlier sets, creating a single body with the stockings.

When the upper is in equilibrium with the ambient temperature, it is removed from the shoe tree and is ready for the following steps.

In the following steps, a sole 7 is constructed on the upper by injection-moulding polyurethane.

The upper is fitted on a special shoe tree on the mould where any components to be overmoulded can be positioned on the said upper and fixed by gluing.

The upper (on the shoe tree) is brought into position so as to be subsequently sealed between two moulding rings during the polyurethane injection step.

The moulding rings for the sole close so as to partially incorporate the upper and form a cavity which is isolated from the outside and is suitable for the injection of polyurethane for the construction of the sole.

Once everything has been prepared as described earlier, the polyurethane injection begins and, due to the presence of the membrane element 3, the polyurethane meets a barrier that limits the flow thereof towards the inner part of the upper.

In more detail, the shape of the membrane element 3 prevents the polyurethane injected into the sole flowing towards the internal stocking, allowing only predetermined amounts of polyurethane to flow through, and only through the perforations 30. The amount of material that flows through the perforations allows the creation of joint points between the sole and the upper and, in particular, with the internal stocking.

Without the presence of the membrane element 3, as configured, an excessive amount of polyurethane would filter through to the upper, altering both the functional and the aesthetic characteristics thereof. More precisely, the polyurethane does flow through, but only minimally and the flow is controlled and managed by the perforations in the membrane element 3; the polyurethane that flows through creates a uniform bridge of cohesion between the internal stocking of the upper and the sole injected onto the upper, forming holding hooks 35.

Once the injection step is complete, the sole moulding rings open and the shoe (upper+sole) is complete and is removed from the mould and then removed from the shoe tree.

There is a step consisting of trimming the sole to remove any moulding burrs and then the shoe is ready.

As can be deduced from the above, the shoe obtained with the procedure described comprises an upper 2 formed of a pair of stockings, one rolled top of the other, where stabilising elements are no longer housed inside the stockings, except for the heel protection element and for the stiffening of this part.

In accordance with the present invention, the membrane element 3 is shaped, variable, and modulable according to the sole and the lateral profile to be obtained as an aesthetic aspect.

In fact, the profile/section of the membrane element 3 varies from sector to sector with respect to the shape of the sole depending on the desired protection and structural characteristics.

According to the present embodiment and as mentioned earlier, the membrane element 3 acts as an endo-skeleton—ensuring greater dimensional stability—and as a cohesive agent between the two stockings, creating a sort of single body.

In particular, the lateral edge that is created on top of the sole, in the part where the second and third portions are located, creates a protective element for the upper, which is positioned so that it ensures continuity between the sole and the upper, providing a continuous, uniform profile.

In particular, when the polyurethane material is injected to make the sole, the membrane element is able to accommodate material, as a result of which a good joint is created between the external stocking, the membrane element, and the sole, while holding hooks form where there are perforations.

In addition, the membrane element becomes a selective filter, i.e. a structure that allows different properties to be obtained depending on the perforations, shape, and size thereof. Depending on how the shoe is to be used, differentiated rigidity or flexibility characteristics can be obtained by calibrating and managing the thickness of the membrane to lend the shoe both structural and functional features, as well as varying the thickness of the material to vary the shoe's grip, rigidity, and protection characteristics.

According to the present invention, a knitted upper 2 is obtained which has good intrinsic flexibility which (combined with an injected sole 7 which is rather thin and is much more
flexible both per se and due to the methods of the said procedure) makes the shoe very different from one with a sole which is moulded and then glued or sewn on.

The combination of these embodiment methods results in a shoe with improved characteristics such as lightness, flexibility, dimensional stability, and grip between the parts, unlike shoes made using commonly known systems.

The procedure in question is a production procedure that allows the creation of an object that is a single, homogencous, and compact body, unlike shoes made so far, which are simply an assembly of separate parts constructed at different times rather than during a single production procedure.

In particular, with respect to prior shoe construction processes, the discontinuity and inhomogeneity phenomena encountered in the structure of the shoe that trigger problems over time (in terms of both structural adhesion of the shoe and comfort of the parts thereof) no longer occur.

As described above, the Applicant's shoe described in the aforesaid PCT application was limited in terms of the elastic response of the upper due to the presence of the plantar structure, however, with the use of the membrane element, this situation no longer arises. In fact, the membrane element structures and shapes the lower part of the upper, towards the sole, lending the shoe a structured appearance, which was not the case previously, as the upper was not supported by anything, especially at the toe and along the sides.

This predominantly structural description is now followed by a description of the operation of the present invention.

When a user intends to walk or engage in sports, they simply have to put on a pair of shoes according to the present invention and use them in exactly the same way as those currently in use, with the difference being that the support provided in the various areas of the foot is differentiated from sector to sector, the comfort is optimal and diversified according to the parts of the foot, the climate control is also different from area to area, the heel is better
protected against blows and bumps, and other parts of the foot will be helped and supported as well as protected during the various movements. Furthermore, the flexibility of the shoe will allow the user to keep the shoes on for hours and to walk without any muscle fatigue.

The present invention thus achieves the objects set.

With the procedure in question it is possible to make, within a single production sequence, a shoe with a knitted upper and a sole obtained by direct polyurethane injection, thanks to the presence of a membrane element interposed between the two stockings that comprise the upper.

In fact, the membrane element simplifies and accelerates the shoe construction operations, guarantees good protection for the parts of the foot near the sole against blows, water, and dampness, and/or allows the sole to breathe by creating an air exchange between the foot and the inner sole, thereby promoting foot comfort.

One advantage of the membrane element originates from the fact that the said element lends the shoe, as a whole, particular flexibility, with the result that the user does not tire the muscles in their lower limbs even with prolonged use of the shoe.

Advantageously, with the procedure according to the present invention, a shoe with a knitted upper is made which has differentiated structures to offer good elasticity and flexibility, with an upper offering optimal structuring of the areas that contain the foot, which are elasticised, rigid, breathable, and structured for containment.

Furthermore, the present procedure allows a shoe with a knitted upper to be made which adapts perfectly to the morphology of the foot, offering different functions and behaviour to meet all usage needs.

Another advantage of the procedure is that a shoe with a knitted upper can be made which offers the user optimal foot containment, excellent breathability, decidedly light weight,
support and considerable comfort when worn, as well as significant flexibility and lightness during use thereof.

A further advantage lies in the fact that the shoe in question is simple to manufacture and works well.

Of course, numerous modifications and variations may be made to the present invention while remaining within the scope of the inventive concept that characterises it.

1. Procedure for making a shoe with knitted upper comprising the following steps:
a first step of weaving/construction of an upper (2) which is made by making a double stocking,
a second step that envisages forming the upper in which the two previously constructed stockings feature a “tube” shape that is closed on one side (the tip closed in weaving), whilst the other end of the tube remains open, and the inner stocking is placed on a suitable shoe-tree and the outer stocking is turned on the preceding stocking to form a double layer,
a steam step where the upper on the shoe-tree is subjected to a steam jet that dampens and softens a thermoplastic polymer yarn of which it consists,
a drying step in which the upper is passed through a high-temperature kiln to dry off the residual humidity of the preceding step and make the upper return to the desired dimensions by taking thermoplastic polymeric yarn to the melting temperature,
a parking step in which the upper on the shoe-tree exits a kiln and transits on a roller conveyor yielding heat to the environment to lower the temperature thereof,
a stabilization step in which the upper on the shoe-tree transits through a very low-temperature refrigerator that stabilizes the thermoplastic polymer yarn to fix the upper dimensionally,
a step of removal of the upper from the shoe-tree in which, when the upper is at ambient temperature, it is removed from the shoe-tree,
characterized in that:
during the upper shaping step, once the internal stocking has been placed on the shoe-tree, a membrane element (3) is placed covering the portion corresponding to the sole of the shoe-tree and a side portion, the said membrane element is a single-body element consisting of a polymeric membrane which has adhesive material on both surfaces and features a series of suitable shaped and positioned perforations (30), the said membrane element providing a support structure for the two stockings so that the shoe obtained has and maintains a structured shape, then the second stocking—with the open end—is pulled over the first so that it is completely covering the shoe-tree,
once removed from the shoe-tree, the upper is ready for the construction of an insole (7) with the insertion of the upper into a special mould, the positioning of the shoe-tree plus upper, and the clamping of the upper between two moulding rings for a polyurethane injection step (in which the moulding rings are clamped together so that they partially incorporate the upper, forming a cavity which is isolated from the outside into which the polyurethane can be injected so as to form the insole and during which the polyurethane—due to the presence of the membrane element—encounters a barrier that limits the flow thereof towards the inner part of the upper), followed by the filling of the mould and the flow of predetermined amounts of polyurethane through the perforations (30) in the membrane element, thereby creating joint points between the insole and the upper and with the inner sock, without interfering with and without altering the functional and aesthetic characteristics, followed by the opening of the moulding rings once the injection step is complete, removal of the complete shoe (upper plus insole) from the mould and from the shoe-tree, the said procedure creating a shoe that is a single, homogeneous, compact and structured body.

2. Procedure according to claim 1, characterized in that, when the upper is passed through the kiln, the adhesive material present on the surfaces of the membrane element heats up, activates, softens, and starts to melt and therefore flow between the stitches of the internal and external stockings, creating a bridge to form cohesion between the two layers of knitting and giving rise to a single structure and the said membrane element, adhering to the two layers of knitting (i.e. to the two stockings), gives support to the knitting and therefore structure to the shoe.

3. Procedure according to claim 1, characterized in that, during the injection step, the passage of the polyurethane occurs minimally and in a controlled and managed manner through the perforations in the membrane element (3) and the polyurethane that passes creates a uniform adhesion bridge between the inner stocking of the upper and the sole injected on the upper to form holding hooks (35).

4. Shoe made with the procedure according to claim 1, of the type comprising an upper (2) formed from a pair of stockings, one on top of the other, where a heel reinforcement element (4) is located inside the stockings for protection and stiffening of this part and characterized by the fact that interposed between the two stockings is a membrane element (3), which is a single-body element consisting of a polymeric membrane and heat sealing double-sided adhesive with a film of adhesive material on both sides thereof, the said polymeric membrane having a thickness ranging from a minimum of 0.5 mm to a maximum of 1.5 mm depending on the level of performance required of the shoe and as the thickness of the membrane increases, a differentiated elasticity of the upper and, consequently, of the shoe is obtained.

5. Shoe according to claim 4, characterized in that the said membrane element (3) is composed of a first portion (31) which corresponds to the conformation of the insole, of a second portion (32)—which creates a side edge that runs from the heel, up the instep, to the toe and ends at the beginning of the outer forefoot—and a third portion (33), which starts at the heel and meets the second portion at the outer forefoot.

6. Shoe according to claim 4, characterized in that the three portions (31, 32, 33) of the membrane element (3) are obtained from a single piece of a membrane sheet, where they are cut out by punching and, once the shape has been cut out, the second portion (32) is joined by a seam which runs along the perimeter edge of the first portion, along the section including the heel, the instep, the toe, and up to the outer side at the outer forefoot, while the third portion (33) is joined to the first portion also at the peripheral edge of the first portion (31) and is not affected by the second portion in the section running from the outer forefoot to the heel and the second portion is joined vertically to the third one at the heel and the outer forefoot.

7. Shoe according to claim 4, characterized in that the first portion (31) of the said membrane element (3) has a series of perforations (30) which are suitably positioned so as to create adhesion points between the insole and the upper when the polyurethane is injected into mould for the creation of the insole and the conformation of the membrane element (3) prevents the injected polyurethane in the insole flowing towards the inner stocking, allowing only predetermined amounts of polyurethane to pass through the said perforations (30) and the amount of polyurethane that flows through the perforations allows the creation of joint points between the insole and the upper and, in particular, with the inner stocking.

8. Shoe according to claim 4, characterized in that said membrane element (3) constitutes a support structure for the two stockings which, as knitted, would not be able to support themselves and in this way, the shoe obtained has and maintains a structured shape.

9. Shoe according to claim 4, characterized in that the said membrane element (3) consists of a closed cell polymer that provides good protection for both the knitted part and the user's foot.

10. Shoe according to claim 4, characterized in that in the said membrane element (3), the vertical heights of the second portion (32) and the third portion (33) varies from area to area all the way around the perimeter of the foot depending on the structural performance desired, thereby creating a protective edge which, depending on the position, allows the toe to be cushioned against blows and any water or moisture which may enter in the event of rain or of water on the ground, protecting the internal instep part against any water or moisture which may enter and providing a support and sealing structure for the arch area, while the outer side part is cushioned against blows and any water or moisture which may enter, where the edge also offers dimensional stability which ensures the upper maintains its shape over time and use and, in the heel area, the edge that is created is higher to provide the said area with greater stability as well as providing the upper with greater wear resistance, the said second and third portions featuring perforations to provide the shoe with different degrees of breathability.

11. Shoe according to claim 4, characterized in that an increasing the thickness of the membrane element increases the shoe's insulation capacity, thereby maintaining the internal temperature and ensuring good foot comfort.

12. Shoe according to claim 4, characterized in that, when the upper is passed through the kiln, the adhesive material present on the surface of the membrane element heats up, activates, softens, and starts to melt and therefore flow between the stitches of the internal and external stockings, creating a bridge to form cohesion between the two layers of knitting and giving rise to a single structure since the said membrane, adhering to the two layers of knitting (i.e. to the two stockings), gives support to the knitting and therefore structure to the shoe and the structure of the upper, which is created as a single body which is nevertheless soft because the membrane is elastic and contains air within the closed cell structure thereof.
